(19) United States
(12) Patent Application Publication
(10) Pub. No.: US 2003/0051369 A1
(43) Pub. Date: Mar. 20, 2003

(54) Integral dryer

(76) Inventor: Richard Aust, (US)

Correspondence Address: Todd T. Taylor, TAYLOR & AUST, P.C., 142 S. Main St., P.O. Box 560, Avilla, IN, 46710, US

(21) Appl. No.: 10/245,025

(22) Filed: Sep. 17, 2002

(30) Foreign Application Priority Data
Sep. 18, 2001 (DE) 10146032.5

(51) Int. Cl. F26B 3/34

(52) U.S. Cl. 34/273; 34/444; 34/611

(57) ABSTRACT

A method and apparatus for drying a moving material web, including pre-drying the web in an infrared dryer including at least one infrared radiator and drying the web in an air dryer including a dryer air, the air dryer operated such that a heat transfer coefficient between the dryer air and the web progresses in an ascending way as viewed in the direction of web travel.

### BACKGROUND OF THE INVENTION

1. Field of the Invention

The present invention relates to a method and a device for drying a moving material web, and, more particularly, to a method and a device for drying a coated paper or cardboard web.

2. Description of the Related Art

It is generally known that, in the production of paper and cardboard webs that are coated with coating colour, dryer systems are used for drying the webs following the coating application that include infrared radiators or air dryers utilizing hot air. In this context it is common practice to utilize the waste heat from an infrared radiator in a downstream air dryer. In the article by Sommer and Aust “IR Drying Concepts for High Energy Yield” (Weekly paper for Paper Production 22, 1997) a so-called integral dryer is featured, whereby an air dryer that utilizes the waste heat from the infrared radiators is located immediately following an infrared dryer, thereby increasing the drying efficiency. To this end, air is blown against the web in the location of the IR radiators and subsequently sucked off. This heated air that is loaded with water vapor is subsequently used as dryer air in the following air dryer.

In drying coated paper or cardboard webs it became evident that problems occur in the finished product, for example with regard to printability, if the evaporation rate during drying exceeds predetermined values.

What is needed in the art is a drying method and a dryer device permitting intensive drying at a high level of efficiency, over as short as possible a web length of coated paper or cardboard webs, without impairing the quality of the finished product.

### SUMMARY OF THE INVENTION

The present invention provides operating the air dryer in such a manner that the coefficient of heat transfer between the dryer air and the web, viewed in direction of web travel progresses in an ascending way.

The present invention comprises, in one form thereof, a method and apparatus for drying a moving material web, including pre-drying the web in an infrared dryer including at least one infrared radiator and drying the web in an air dryer including dryer air, the air dryer operated such that a heat transfer coefficient between the dryer air and the web progresses in an ascending way as viewed in the direction of web travel.

On passing the web through the air dryer, the drying process is initially carried out at a low and then at a successively increasing heat transfer coefficient. The relatively low heat transfer coefficient at the beginning of the drying process (convection drying) results in that the sudden increase in the evaporation rate at the beginning of the convection drying process in known integral dryers turns out to be considerably lower. Exceeding the limiting value of the evaporation rate that would affect the quality of the finished product is hereby avoided. After the evaporation rate has decreased sufficiently due to the reduction in web temperature, drying is carried out with an increased heat transfer coefficient, so that the same drying rate is achieved, compared to the dryer length of known dryer systems.

Convection drying in the air dryer is preferably conducted in several stages. The air dryer includes several nozzles extending transversely across the web and positioned in tandem, viewed in direction of web travel, that are operated in such a manner so that the heat transfer coefficient increases gradually.

The increase of the heat transfer coefficient is preferably brought about in that the area specific air stream, that is the air volume per time and web surface, increases in each stage of the air dryer.

Alternatively, other parameters that influence the heat transfer coefficient can be changed, for example the air flow velocity.

An advantage of the present invention is high intensity drying at a high level of efficiency, over as short as possible a web length of coated paper or cardboard webs, without impairing the quality of the finished product.

Yet another advantage is that the heat transfer coefficient increases gradually in the direction of web travel.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic side view of a known integral dryer;

FIG. 2 is a schematic side view of an embodiment of a dryer according to the present invention;

FIG. 3 is a graph showing the progression of the evaporation rate during drying, as a comparison between known drying methods (curve 1) and drying methods (curve 2) according to an embodiment of the present invention; and

FIG. 4 is a graph showing a corresponding comparison of web temperatures during drying for known drying methods (curve 1) and drying methods (curve 2) according to an embodiment of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

Referring now to the drawings, and more particularly to FIG. 2, there is shown an embodiment of the dryer system according to the present invention including infrared dryer 1, followed by air dryer 2 viewed in direction of web travel L (from left to right in the drawings). Infrared dryer 1 includes several (4 in the embodiment shown in FIG. 2) dryer units 3, that each contain rows of infrared radiators 4 that are provided with aligned radiating surfaces 4a. Infrared radiators 4 are heated with a fluid-air mixture, preferably with a gas-air mixture. At each of dryer units 3 air is blown in the direction of web B through nozzles 5 on one side. The air that is loaded with exhausts from the radiators 4 and with water vapor is sucked off through suction ports 6 at the other side of each dryer unit 3.

The downstream air dryer 2 includes several (4 in the embodiment shown in FIG. 2) air nozzles 7 that are positioned in direction of web travel L at a distance from each other and extend transversely across the width of web B. Dryer air 8 that is supplied via a common air hood 9 is blown from the air nozzles 7 against the web surface. Suction ports 12 through which the air that is loaded with water vapor is sucked off are located on the underside of air hood 9, between air nozzles 7. Air dryer 2 for drying a coated web B should preferably be in the embodiment of a floatation dryer. In a floatation dryer air nozzles 7 are located above and below web B, through which drying air 8 is blown against the free floating web B. Single sided installations are also possible.

Integral dryer 20 including infrared dryer 1 and air dryer 2 is operated in a manner so that the exhaust air AL from infrared dryer 1 is utilized as dryer air 8 in air dryer 2. Air dryer 2 in the design example does not feature its own air heating apparatus, so that the total drying energy is produced by radiators 4.

Alternatively, it is also possible to equip air dryer 2 with its own air heating apparatus and to mix exhaust air AL from infrared dryer 1 with the produced hot hair HL.

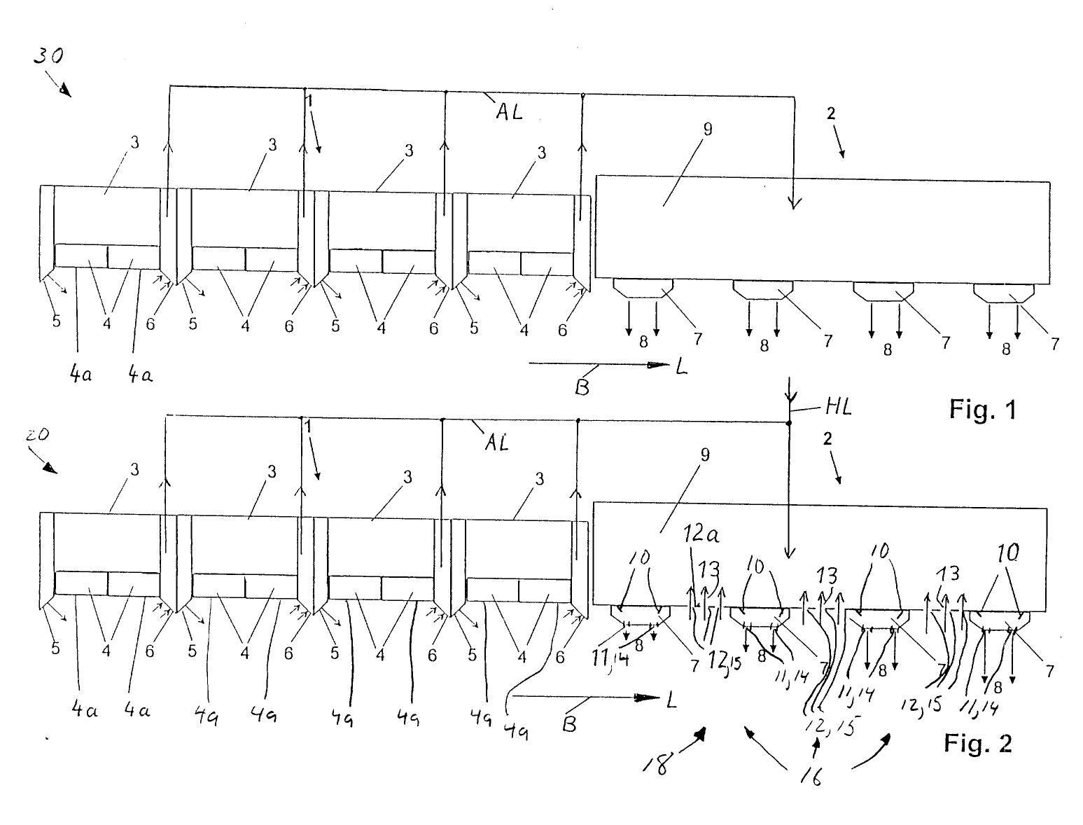

Integral dryer 30 illustrated in FIG. 1 is known and is described in the article by Sommer and Aust “IR Drying Concepts for High Energy Yield” (Weekly paper for paper production 22, 1997). In integral dryer 30 the same flow of dryer air 8 is emitted from each air nozzle 7 of air dryer 2. This is indicated in FIG. 1 by the arrows 8 that are of consistent length, in contrast with an embodiment of the present invention wherein, in the direction of web travel L, increasing flow of dryer air 8 is emitted from air nozzles 7 as shown by arrows 8 of increasing length in FIG. 2.

With the exception of the differences described below, integral dryer 20 according to the present invention, as illustrated in FIG. 2, is consistent with the already known integral dryer 30 in FIG. 1. Integral dryer 20 according to the present invention includes air dryer 2 that is equipped with adjustment elements to adjust the heat transfer coefficient between dryer air 8 and web B in direction of web travel L progressively increasing. An increasing heat transfer coefficient during drying is achieved preferably by progressively increasing the area specific flow of dryer air 8 (that is the air volume per time and m² of web surface) over the length of air dryer 2. For this purpose air nozzles 7 that are positioned behind each other are equipped with adjustment elements permitting adjustment of the flow of dryer air 8 that is emitted from them as shown by the extending arrow lengths at dryer air 8 in FIG. 2 thereby providing an ascending gradient 18. Preferably, adjustment elements take the form of each air nozzle 7 equipped at its air intake with air valve 10 that serves to adjust the stream of dryer air 8 flowing from air hood 9 into air nozzle 7, and thereby also the volume of dryer air 8 flowing from air nozzle 7. Alternatively, or in addition, it is possible to configure the outlet cross section 14 of nozzles ports 11 of each air nozzle 7 variably, so that the flow of dryer air 8 can be progressively increased along the length of the air dryer 2 as shown by the extending arrow lengths at 8.

If it is advantageous for the drying characteristics, air stream 13 that is sucked off between air nozzles 7 and taken away from web B can be adapted to the inlet air coming from air nozzles 7. This can be realized for example by mounting perforated plates 12a that are equipped with suction ports 12 between air nozzles 7 on the underside of air hood 9. The suction port cross section 15 of suction ports 12 and/or the number of suction ports 12 might increase in direction of web travel L to achieve an increased suction cross section 16.

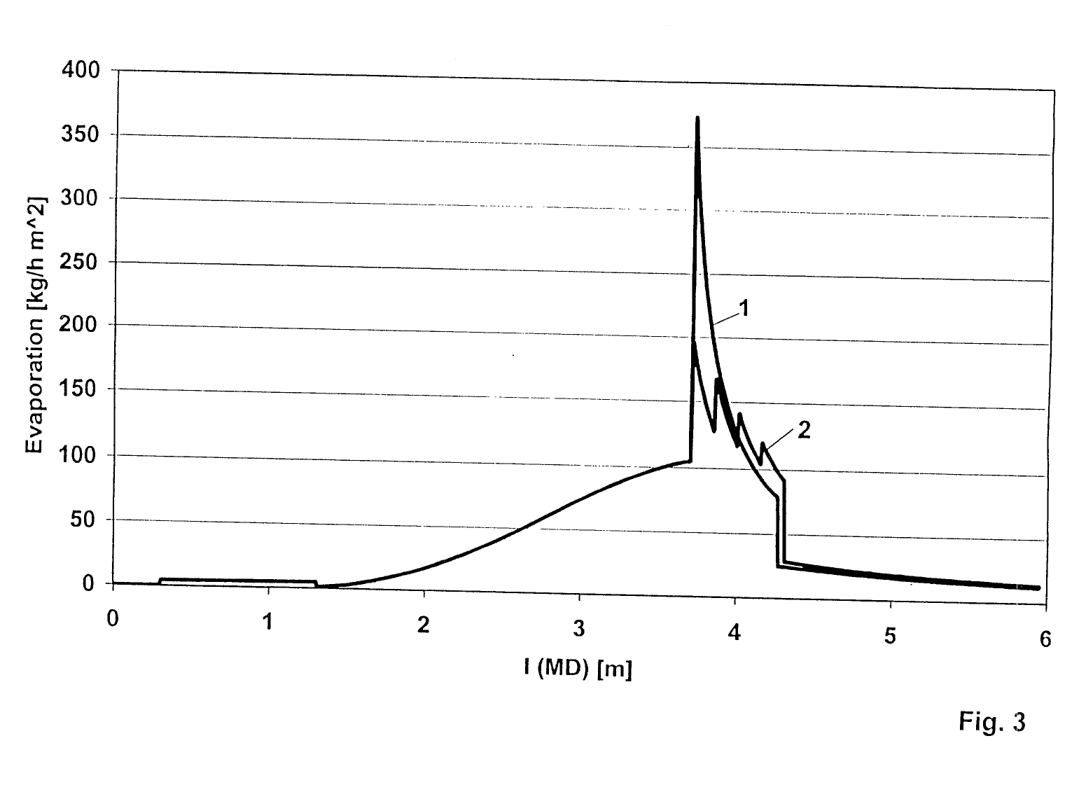

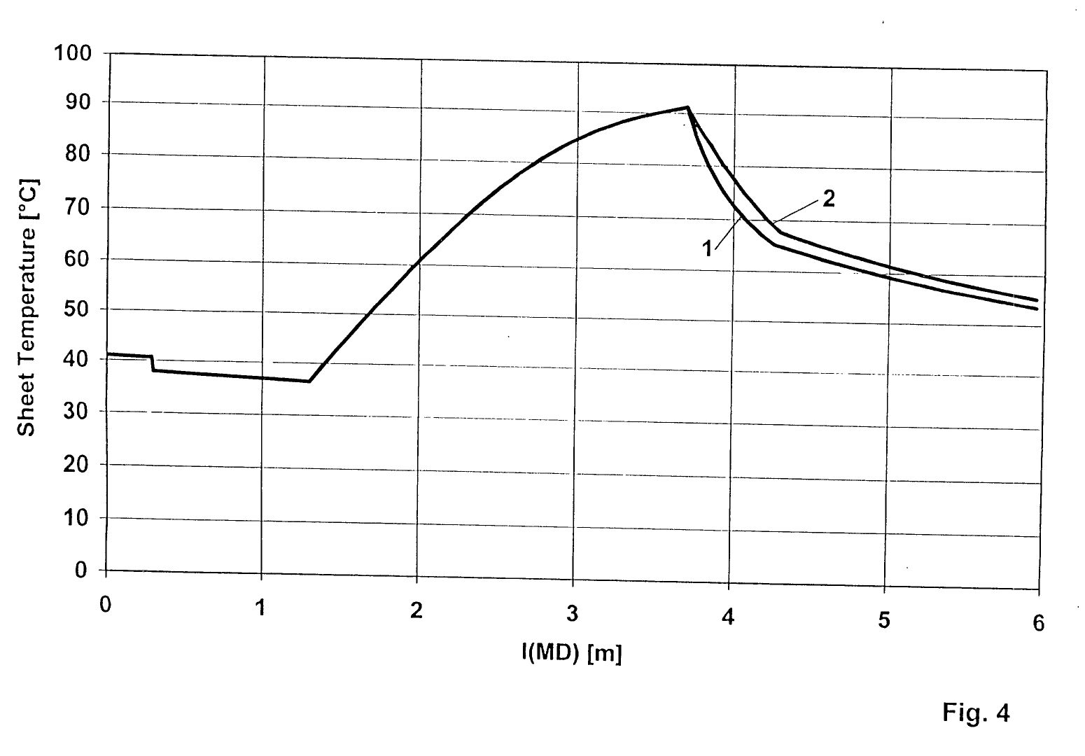

FIGS. 3 and 4 illustrate the different drying progression between the already known dryer 30 according to FIG. 1 (curve 1) and an embodiment of dryer 20 according to the present invention shown in FIG. 2 (curve 2). FIG. 3 illustrates the evaporation rate along the dryer length (shown in machine direction MD) and FIG. 4 illustrates the web temperature along the dryer length.

As can be seen from FIG. 3, in the already known dryer 30 the evaporation rate increases suddenly at the beginning of air dryer 2 and then drops off continuously. In contrast, in dryer 20 according to an embodiment of the present invention, drying occurs at a relatively low heat transfer coefficient at the beginning of air dryer 2, so that the evaporation rate increases considerably less and remains below the predetermined limits, for example 250 kg/hm². Subsequently drying occurs at an increased heat transfer coefficient in second air nozzle 7 due to the increased flow of dryer air 8, so that the evaporation rate increases in this area. Correspondingly, the heat transfer coefficient in the subsequent air nozzles 7 is increased through a further increased flow of dryer air 8, so that a saw tooth type declining progression of the evaporation rate occurs. Since higher evaporation rates occur in dryer 20 according to an embodiment of the present invention toward the end of air dryer 2, compared to the already known dryer 30, the total efficiencies of the two dryers essentially coincide. FIG. 4 shows that the web temperature in dryer 20 according to an embodiment of the present invention drops at a slower rate than in the already known dryer 30 of FIG. 1.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for drying a moving material web, comprising the steps of:
pre-drying the web in an infrared dryer including at least one infrared radiator; and
drying the web in an air dryer including a dryer air, said air dryer operated such that a heat transfer coefficient between said dryer air and the web progresses in an ascending way as viewed in a direction of web travel.

2. The method of claim 1, wherein said dryer air includes an area specific air stream, said area specific air stream increases along a length of said air dryer.

3. The method of claim 1, wherein said infrared dryer includes an exhaust air, said exhaust air is utilized as said dryer air in said air dryer.

4. An apparatus for drying a moving material web, comprising:
an infrared dryer including at least one infrared radiator; and
an air dryer including at least one adjustment element, a dryer air and a heat transfer coefficient between said dryer air and the web, at least one said adjustment element for adjusting said heat transfer coefficient to be progressively increasing in a direction of web travel, said air dryer subsequent to said infrared dryer in said direction of web travel.

5. The apparatus of claim 4, wherein at least one said adjustment element includes at least one air nozzle including at least one air valve, said dryer air adjustably flowing from each said air nozzle.

6. The apparatus of claim 5, wherein at least one said air nozzle includes at least one nozzle port including an outlet cross section, at least one said outlet cross section is variable.

7. The apparatus of claim 4, wherein said air dryer includes an air hood and at least one air nozzle, said dryer air is at least partially supplied to at least one said nozzle through said air hood.

8. The apparatus of claim 4, wherein said infrared dryer includes exhaust air, said exhaust air is mixed with said dryer air.

9. The apparatus of claim 4, wherein said air dryer includes an air hood with a plurality of air nozzles and a plurality of suction ports interposed with said plurality of nozzles wherein at least one of a suction port cross section of said suction ports and a quantity of said suction ports increases in said direction of web travel to achieve an increased suction cross section.
